(19) United States
(12) Patent Application Publication
(10) Pub. No.: US 2026/0031318 A1
(43) Pub. Date: Jan. 29, 2026

(54) HIGH THROUGHPUT STAGGERED ELECTRODE TAB MANUFACTURING PROCESS

(71) Applicant: GM GLOBAL TECHNOLOGY OPERATIONS LLC, Detroit, MI (US)

(72) Inventors: Liang Xi, Northville, MI (US); Xiangji Bu, Okemos, MI (US); Mahboob Murshed, Commerce Township, MI (US); Hyunmin Choe, Rochester Hills, MI (US); SriLakshmi Katar, Troy, MI (US)

(73) Assignee: GM GLOBAL TECHNOLOGY OPERATIONS LLC, Detroit, MI (US)

(21) Appl. No.: 18/783,525

(22) Filed: Jul. 25, 2024

(51) Int. Cl. H01M 4/04; H01M 50/533

(52) U.S. Cl. CPC H01M 4/0404; H01M 50/533

(57) ABSTRACT

Disclosed is a method including depositing a first strip of active material for a battery on an electrically conductive foil, the first strip having a first edge and an opposite second edge, depositing a second strip of active material for the battery on the electrically conductive foil, wherein the second strip has a first edge and an opposite second edge, the first edge of the second strip being spaced a distance from the second edge of the first strip of active material for the battery, forming a first set of a plurality of tabs in the electrically conductive foil extending in a first direction away from the second edge of the first strip, forming a second set of a plurality of tabs in the electrically conductive foil extending in a second direction away from the first edge of the second strip.

### INTRODUCTION

The technical field generally relates to battery electrodes, components, and subassemblies thereof, and methods of making the same.

### BACKGROUND

Battery electrodes have been manufactured utilizing a unidirectional tab layout.

It is desirable to design and manufacture battery electrodes with greater throughput during production. Furthermore, other desirable features and characteristics of the variations disclosed herein will become apparent from the subsequent detailed description and the appended claims, taken in conjunction with the accompanying drawings and the foregoing.

### SUMMARY

A number of variations may include a method including: depositing a first strip of active material for a battery on an electrically conductive foil, the first strip of active material for the battery having a first edge and an opposite second edge, the first strip of active material for the battery having a first width between the first edge and the opposite second edge of the first strip of active material for the battery; depositing a second strip of active material for the battery on the electrically conductive foil, wherein the second strip of active material for the battery has a first edge and an opposite second edge, the first edge of the second strip of active material for the battery being spaced a distance from the second edge of the first strip of active material for the battery, the second strip of active material for the battery having a second width between the first edge and the opposite second edge of the second strip of active material for the battery; the first width being different than the second width; forming a first set of set of a plurality of tabs in the electrically conductive foil extending in a first direction away from the second edge of the first strip of active material for the battery; forming a second set of set of a plurality of tabs in the electrically conductive foil extending in a second direction away from the first edge of the second strip of active material for the battery.

A number of variations may include a method wherein the first set of set of a plurality of tabs formed in the electrically conductive foil and the second set of set of a plurality of tabs formed in electrically conductive foil are in a staggered relationship to each other.

A number of variations may include a method wherein the second width is twice the first width.

A number of variations may include a method further including slitting the second strip and the electrically conductive foil midway between the first edge and the second edge of the second strip.

A number of variations may include a method further including forming a third set of set of a plurality of tabs in the electrically conductive foil extending in the first direction away from the second edge of the second strip of active material for the battery.

A number of variations may include a method further including depositing a third strip of active material for the battery on the electrically conductive foil, the third strip of active material for the battery having a first edge and an opposite second edge, the third strip of active material for the battery having a third width between the first edge and second edge of the third strip of active material for the battery.

A number of variations may include a method wherein the third width is twice the first width.

A number of variations may include a method further including slitting the third strip and the electrically conductive foil midway between the first edge and the second edge of the third strip.

A number of variations may include a method further including forming a fourth set of a plurality of tabs in the electrically conductive foil extending in the second direction away from the first edge of the third strip of active material for the battery.

A number of variations may include a method wherein the third set of set of a plurality of tabs formed in the electrically conductive foil and the fourth set of set of a plurality of tabs formed in electrically conductive foil are in a staggered relationship to each other.

A number of variations may include a method further including forming a fifth set of set of a plurality of tabs in the electrically conductive foil extending in the first direction away from the second edge of the third strip of active material for the battery.

A number of variations may include a method further including depositing a fourth strip of active material for the battery on the electrically conductive foil, the fourth strip of active material for the battery having a first edge and an opposite second edge, the fourth strip of active material for the battery having a fourth width between the first edge and second edge of the fourth strip of active material for the battery.

A number of variations may include a method wherein the fourth width is equal to the first width.

A number of variations may include a method further including forming a sixth set of set of a plurality of tabs in the electrically conductive foil extending in the second direction away from the first edge of the fourth strip of active material for the battery.

A number of variations may include a method wherein the sixth set of set of a plurality of tabs formed in the formed in the electrically conductive foil and the fifth set of set of a plurality of tabs formed in electrically conductive foil are in a staggered relationship to each other.

A number of variations may include a method further including slitting the electrically conductive foil near the second edge of the fourth strip of active material for the battery.

A number of variations may include a method further including slitting the electrically conductive foil near the first edge of the first strip of active material for the battery.

A number of variations may include a method including: depositing a first strip of active material for a battery on an electrically conductive foil, the first strip of active material for the battery having a first edge and an opposite second edge, the first strip of active material for the battery having a first width between the first edge in the opposite second edge of the first strip of active material for the battery; forming a first set of set of a plurality of tabs in the electrically conductive foil extending in a first direction away from the second edge of the first strip of active material for the battery; forming a second set of set of a plurality of tabs in the electrically conductive foil extending in a second direction away from the first edge of the first strip of active material for the battery slitting the first strip and the electrically conductive foil midway between the first edge and the second edge of the first strip.

A number of variations may include a method further including depositing a second strip of active material for the battery on the electrically conductive foil, wherein the second strip of active material for the battery has a first edge and an opposite second edge, the first edge of the second strip of active material for the battery being spaced a distance from the second edge of the first strip of active material for the battery, the second strip of active material for the battery having a second width between the first edge in the opposite second edge of the second strip of active material for the battery; forming a third set of set of a plurality of tabs in the electrically conductive foil extending in the second direction away from the first edge of the first strip of active material for the battery; forming a fourth set of set of a plurality of tabs in the electrically conductive foil extending in a first direction away from the second edge of the second strip of active material for the battery; slitting the second strip and the electrically conductive foil midway between the first edge and the second edge of the second strip.

A number of variations may include a method including: depositing a first strip of active material for a battery on an electrically conductive foil, the first strip of active material for the battery having a first edge and an opposite second edge, the first strip of active material for the battery having a first width between the first edge and the opposite second edge of the first strip of active material for the battery; depositing a second strip of active material for the battery on the electrically conductive foil, wherein the battery has a first edge and an opposite second edge, the first edge of the second strip of active material for the battery being spaced a distance from the second edge of the first strip of active material for the battery, the second strip of active material for the battery having a second width between the first edge and the opposite second edge of the second strip of active material for the battery; the second width being twice the first width; depositing a third strip of active material for a battery on an electrically conductive foil, the third strip of active material for the battery having a first edge and an opposite second edge, the third strip of active material for the battery having a third width between the first edge and the opposite second edge of the first strip of active material for the battery; the third width being equal to the second width; depositing a fourth strip of active material for the battery on the electrically conductive foil, wherein the fourth strip has a first edge and an opposite second edge, the first edge of the fourth of active material for the battery being spaced a distance from the second edge of the third strip of active material for the battery, the fourth strip of active material for the battery having a fourth width between the first edge in the opposite second edge of the fourth strip of active material for the battery; the fourth width being equal to the first width.

### BRIEF DESCRIPTION OF THE DRAWINGS

The variations will hereinafter be described in conjunction with the following drawing figures, wherein like numerals denote like elements, and wherein:

FIG. 1 is an illustration of a subassembly formed in process of making battery electrodes having a staggered tab layout according to a number of variations;

FIG. 2 is an illustration of a battery electrode made from the subassembly illustrated in FIG. 1;

FIG. 3 illustrates a method of forming a subassembly in the process of making battery electrodes including laser cutting electrode tabs in a staggered tab layout and laser slitting a side of the subassembly;

FIG. 4. Illustrates a method of forming a subassembly in the process of making battery electrodes using a mechanical notching tool producing a staggered tab layout of the subassembly;

FIG. 5 is an illustration of a method including using a mechanical notching tool capable of cutting a single lane with a unidirectional tab layout of the subassembly in the process of making battery electrodes; and

FIG. 6 is an illustration of a method including using a mechanical notching tool capable of cutting two lanes with a staggered tab layout of the subassembly in the process of making battery electrodes according to a number of variations.

### DETAILED DESCRIPTION

The following detailed description is merely illustrative in nature and is not intended to limit the application and uses. Furthermore, there is no intention to be bound by any expressed or implied theory presented in the preceding technical field, background, brief summary or the following detailed description.

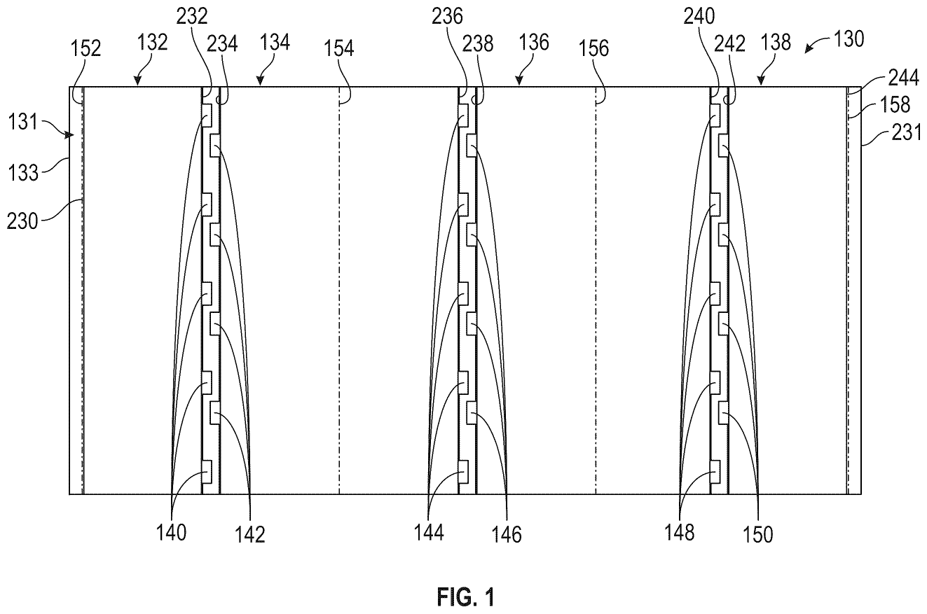

FIG. 1 illustrates a subassembly formed in a step of high throughput staggered electrode tabs method of making battery electrodes using. A subassembly 130 may be formed by providing an electrically conductive foil 131. The electrically conductive foil 131 may include a metal, such as but not limited to, copper or aluminum, or alloys thereof. A first strip 132 of active material for the battery may be deposited so that a first edge 230 of the first strip 132 of active material for the battery is at a distance from the first edge 133 of the electrically conductive foil 131. The active material may be deposited with a composition including metal oxides as the active material along with one or more conductive additives and one or more binders. For the cathode electrode that active material may include, but not limited to, at least one of lithium cobalt oxide (LiCoO2), lithium manganese oxide (LiMn2O4), lithium iron phosphate (LiFePO4 or LIP), or lithium nickel manganese cobalt oxide (LiNiMnCoO2 or NMC). For the anode electrode the active material may include, but not limited to, at least one of carbon-based materials like graphite, silicon, or a combination of both. The first strip 132 of active material for the battery may have a first width between the first edge 230 and a second edge 232. A second strip 134 of active material for the battery may be deposited on the electrically conductive foil so that a first edge 234 of the second strip 134 is spaced a distance from the second edge 232 of the first strip 132 of active material for the battery. In a number of variations, the second strip 134 of active material for the battery may have a second width between the first edge 234 and a second edge 236 of the second strip 134 of active material for the battery. In a number of variations, the first width and the second width being different from each other. For example, but not limited to, the second width may be twice as wide as the first width. A third strip 136 of active material for the battery may be deposited on the electrically conductive foil 131 so that a first edge 238 of the third strip 136 of active material for the battery is spaced a distance from a second edge 236 of the second strip 134 of active material for the battery. In a number of variations, the third strip 136 of active material for the battery may have a third width between the first edge 238 and a second edge 240 of the third strip 136 of active material for the battery. In a number of variations, the third width may be twice as wide as the first width. A fourth strip 138 of active material for the battery may be deposited on the electrically conductive foil 131 so that a first edge 242 of the fourth strip 138 of active material for the battery is spaced a distance from the second edge 240 of the third strip 136, and a second edge 244 of the third strip 136 of active material for the battery is spaced a distance from a second edge 231 of the electrically conductive foil 131.

A first set of a set of set of a plurality of spaced apart electrode tabs 140 may be formed out of the electrically conductive foil 131 using any of a variety of means including laser cutting or machine cutting and may extend in a first direction away from the second edge 232 of the first strip 132 of active material for the battery. A second set of a plurality of spaced apart electrode tabs 142 may be formed out of the electrically conductive foil 131 using any of a variety of means including laser cutting or machine cutting and may extend in a second direction, opposite the first direction, away from the first edge 234 of the second strip 134 of active material for the battery. The first set of a plurality of spaced apart electrode tabs 140 and the second set of a plurality of spaced apart electrode tabs 142 are formed out of the electrically conductive foil 131 in a staggered relationship to each other. A third set of a plurality of spaced apart electrode tabs 144 may be formed out of the electrically conductive foil 131 using any of a variety of means including laser cutting or machine cutting and may extend in the first direction away from the second edge 236 of the second strip 134 of active material for the battery. A fourth set of a plurality of spaced apart electrode tabs 146 may be formed out of the electrically conductive foil 131 using any of a variety of means including laser cutting or machine cutting and may extend in the second direction away from the first edge 238 of the third strip 136 of active material for the battery. A fifth set of a plurality of spaced apart electrode tabs 148 may be formed out of the electrically conductive foil 131 using any of a variety of means including laser cutting or machine cutting and may extend in the first direction away from the second edge 240 of the third strip 136 of active material for the battery. A sixth set of a plurality of spaced apart electrode tabs 150 may be formed out of the electrically conductive foil 102 using any of a variety of means including laser cutting or machine cutting and may extend in the second direction away from the first edge 242 of the fourth strip 138 of active material for the battery.

A first slit 152 may be formed through the electrically conductive foil 131 near the first edge 230 of the first strip 132 of active material for the battery. A second slit 154 is formed through the second strip 134 of active material for the battery and though the electrically conductive foil 102 at a location which may be midway between the first edge 234 and the second edge 236 of the second strip 134 of active material for the battery. A third slit 156 may be formed through the third strip 136 of active material for the battery and though the electrically conductive foil 102 at a location which may be midway between the first edge 238 and the second edge 240 of the third strip 136 of active material for the battery. A fourth slit 158 is formed in the electrically conductive foil 102 near a second edge 244 of the fourth strip 138 of active material for the battery. The above steps may produce six sections of electrically conductive foil 131 with a set of a plurality of tabs and active material for the battery deposited on the electrically conductive foil 131.

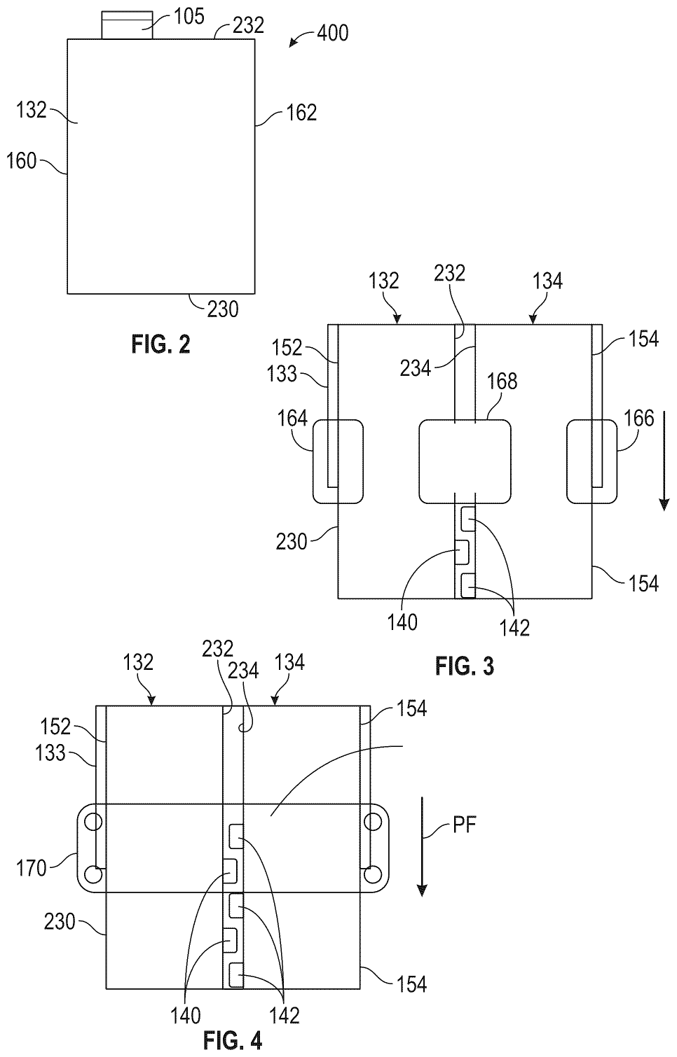

Each one of the six sections may be cut to produce a set of a plurality of battery electrodes 400, for example, as illustrated in FIG. 2. The battery electrode 400 illustrate in FIG. 2 may include an electrode tab 105, a top edge from the second edge 232 of the first strip 132 active material for a battery deposited on the electrically conductive foil 131 shown in FIG. 2, a bottom edge from the first edge 230 of the first strip 132, and opposite side edges 160 and 162 formed by two cuts extending perpendicularly from the first edge 230 to second edge 232, respectively, in the first strip 132 of active material for the battery.

FIG. 3 illustrates a first and second lasers 164, 166 of a two laser system 168 for cutting the set of a plurality of tabs 140, 142 in a staggered relationship, forming slits in the electrically conductive foil, and the electrically conductive foil and the active material for the battery deposited on the electrically conductive foil 131.

FIG. 4. Illustrates a method of forming a subassembly in the process of making battery electrodes using a mechanical notching tool producing a staggered tab layout of the subassembly.

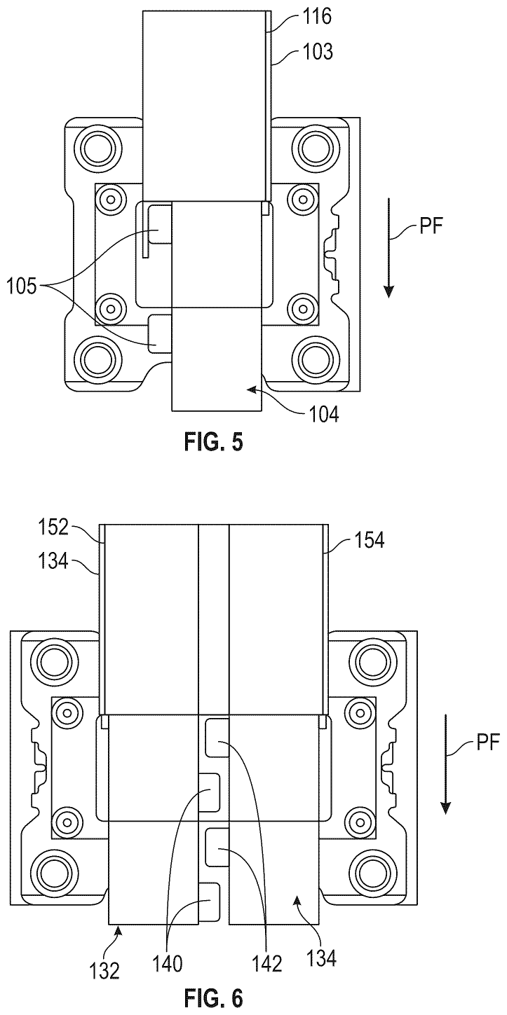

FIG. 5 is an illustration of a method including using a mechanical notching tool capable of cutting a single lane with a unidirectional tab layout of the subassembly in the process of making battery electrodes.

FIG. 6 is an illustration of a method including using a mechanical notching tool capable of cutting two lanes with a staggered tab layout of the subassembly in the process of making battery electrodes according to a number of variations. While at least one illustrative variation has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
depositing a first strip of active material for a battery on an electrically conductive foil, the first strip of active material for the battery having a first edge and an opposite second edge, the first strip of active material for the battery having a first width between the first edge in the opposite second edge of the first strip of active material for the battery;
depositing a second strip of active material for the battery on the electrically conductive foil, wherein the second strip of active material for the battery has a first edge and an opposite second edge, the first edge of the second strip of active material for the battery being spaced a distance from the second edge of the first strip of active material for the battery, the second strip of active material for the battery having a second width between the first edge and the opposite second edge of the second strip of active material for the battery;
the first width being different than the second width;
forming a first set of a plurality of tabs in the electrically conductive foil extending in a first direction away from the second edge of the first strip of active material for the battery; and
forming a second set of a plurality of tabs in the electrically conductive foil extending in a second direction away from the first edge of the second strip of active material for the battery.

2. The method as set forth in claim 1 wherein the first set of a plurality of tabs formed in the electrically conductive foil and the second set of a plurality of tabs formed in electrically conductive foil are in a staggered relationship to each other.

3. The method as set forth in claim 1 wherein the second width is twice the first width.

4. The method as set forth in claim 3 further comprising slitting the second strip and the electrically conductive foil midway between the first edge and the second edge of the second strip.

5. The method as set forth in claim 1 further comprising forming a third set of a plurality of tabs in the electrically conductive foil extending in the first direction away from the second edge of the second strip of active material for the battery.

6. The method as set forth in claim 5 further comprising depositing a third strip of active material for the battery on the electrically conductive foil, the third strip of active material for the battery having a first edge and an opposite second edge, the third strip of active material for the battery having a third width between the first edge and second edge of the third strip of active material for the battery.

7. The method as set forth in claim 6 wherein the third width is twice the first width.

8. The method as set forth in claim 7 further comprising slitting the third strip and the electrically conductive foil midway between the first edge and the second edge of the third strip.

9. The method as set forth in claim 6 further comprising forming a fourth set of a plurality of tabs in the electrically conductive foil extending in the second direction away from the first edge of the third strip of active material for the battery.

10. The method as set forth in claim 9 wherein the third set of a plurality of tabs formed in the electrically conductive foil and the fourth set of a plurality of tabs formed in electrically conductive foil are in a staggered relationship to each other.

11. The method as set forth in claim 6 further comprising forming a fifth set of a plurality of tabs in the electrically conductive foil extending in the first direction away from the second edge of the third strip of active material for the battery.

12. The method as set forth in claim 11 further comprising depositing a fourth strip of active material for the battery on the electrically conductive foil, the fourth strip of active material for the battery having a first edge and an opposite second edge, the fourth strip of active material for the battery having a fourth width between the first edge and second edge of the fourth strip of active material for the battery.

13. The method as set forth in claim 12 wherein the fourth width is equal to the first width.

14. The method as set forth in claim 12 further comprising forming a sixth set of a plurality of tabs in the electrically conductive foil extending in the second direction away from the first edge of the fourth strip of active material for the battery.

15. The method as set forth in claim 14 wherein the sixth set of a plurality of tabs formed in the formed in the electrically conductive foil and the fifth set of a plurality of tabs formed in electrically conductive foil are in a staggered relationship to each other.

16. The method as in claim 12 further comprising slitting the electrically conductive foil near the second edge of the fourth strip of active material for the battery.

17. The method as set for in claim 1 further comprising slitting the electrically conductive foil near the first edge of the first strip of active material for the battery.

18. A method comprising:
depositing a first strip of active material for a battery on an electrically conductive foil, the first strip of active material for the battery having a first edge and an opposite second edge, the first strip of active material for the battery having a first width between the first edge in the opposite second edge of the first strip of active material for the battery;
forming a first set of a plurality of tabs in the electrically conductive foil extending in a first direction away from the second edge of the first strip of active material for the battery;
forming a second set of a plurality of tabs in the electrically conductive foil extending in a second direction away from the first edge of the first strip of active material for the battery; and
slitting the first strip and the electrically conductive foil midway between the first edge and the second edge of the first strip.

19. The method as set forth in claim 18 further comprising depositing a second strip of active material for the battery on the electrically conductive foil, wherein the second strip of active material for the battery has a first edge and an opposite second edge, the first edge of the second strip of active material for the battery being spaced a distance from the second edge of the first strip of active material for the battery, the second strip of active material for the battery having a second width between the first edge in the opposite second edge of the second strip of active material for the battery;
forming a third set of a plurality of tabs in the electrically conductive foil extending in the second direction away from the first edge of the first strip of active material for the battery;
forming a fourth set of a plurality of tabs in the electrically conductive foil extending in a first direction away from the second edge of the second strip of active material for the battery;
slitting the second strip and the electrically conductive foil midway between the first edge and the second edge of the second strip.

20. A method comprising:
depositing a first strip of active material for a battery on an electrically conductive foil, the first strip of active material for the battery having a first edge and an opposite second edge, the first strip of active material for the battery having a first width between the first edge and the opposite second edge of the first strip of active material for the battery;
depositing a second strip of active material for the battery on the electrically conductive foil, wherein the second strip of active material for the battery has a first edge and an opposite second edge, the first edge of the second strip of active material for the battery being spaced a distance from the second edge of the first strip of active material for the battery, the second strip of active material for the battery having a second width between the first edge and the opposite second edge of the second strip of active material for the battery;
the second width being twice the first width;
depositing a third strip of active material for a battery on an electrically conductive foil, the third strip of active material for the battery having a first edge and an opposite second edge, the third strip of active material for the battery having a third width between the first edge and the opposite second edge of the first strip of active material for the battery;
the third width is equal to the second width;
depositing a fourth strip of active material for the battery on the electrically conductive foil, wherein the fourth strip of active material for the battery has a first edge and an opposite second edge, the first edge of the fourth strip of active material for the battery being spaced a distance from the second edge of the third strip of active material for the battery, the fourth strip of active material for the battery having a fourth width between the first edge in the opposite second edge of the fourth strip of active material for the battery; and
the fourth width is equal to the first width.
